(19) United States
(12) Patent Application Publication
(10) Pub. No.: US 2009/0313546 A1
(43) Pub. Date: Dec. 17, 2009

(54) AUTO-EDITING PROCESS FOR MEDIA CONTENT SHARED VIA A MEDIA SHARING SERVICE

(75) Inventors: Ravi Reddy Katpelly, Durham, NC (US); Richard J. Walsh, Raleigh, NC (US); Hugh Svendsen, Chapel Hill, NC (US); Scott Curtis, Durham, NC (US)

Correspondence Address: WITHROW & TERRANOVA CT, 100 REGENCY FOREST DRIVE , SUITE 160, CARY, NC, 27518, US

(73) Assignee: Porto Technology, LLC, Wilmington, DE (US)

(21) Appl. No.: 12/139,676

(22) Filed: Jun. 16, 2008

(51) Int. Cl. G06F 3/048

(52) U.S. Cl. 715/723

(57) ABSTRACT

The present invention relates to providing automatic or programmatic editing of video items. More specifically, in the preferred embodiments, an auto-editing function is provided for performing auto-editing of video items shared via a video sharing service.

### FIELD OF THE INVENTION

The present invention relates to an auto-editing process for a media item, such as a video.

### BACKGROUND OF THE INVENTION

Video sharing services, such as video sharing websites, are becoming increasingly popular. For example, the video sharing website YouTube reportedly serves approximately 100 million videos per day and has estimated bandwidth costs of more than one-million dollars per month. Most of the videos shared by such video sharing services are user-generated videos. Typically, user-generated videos may include objectionable content, undesirable or low value content, or both objectionable content and undesirable or low value content. Objectionable content may be content such as, for example, profanity, violence, nudity, or the like. Undesirable or low value content may be, for example, segments recorded during a quick pan, recorded during a quick zoom, having little or no activity, or the like. As such, there is a need for a system and method for decreasing bandwidth and storage costs for video sharing services while also addressing the issue of objectionable content and/or undesirable or low value content.

### SUMMARY OF THE INVENTION

The present invention relates to providing automatic or programmatic editing of video items. More specifically, in the preferred embodiments, an auto-editing function is provided for performing auto-editing of video items shared via a video sharing service. In general, a user identifies a video item to be shared via the video sharing service. The video item is preferably a user-generated video. The auto-editing function then analyzes the video item to identify objectionable content, undesirable content, or both objectionable content and undesirable content. Based on one or more defined rules, proposed edits for filtering or removing some or all of the objectionable content, the undesirable content, or both the objectionable content and the undesirable content from the video item are generated for each of one or more alternate versions of the video item. Results of the auto-editing process including the proposed edits for each of the one or more alternate versions may be presented to the user. The user may then be enabled to perform additional advance editing features. Once editing is complete, the user selects one or more of the alternate versions of the video item to publish via the video sharing service. Thereafter, the published versions of the video item are shared with one or more other users, or viewers, via the video sharing service.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a system wherein video items shared via a video sharing system are automatically edited according to a first embodiment of the present invention;

FIG. 2 illustrates the operation of the system of FIG. 1 according to one embodiment of the present invention;

FIG. 3 is a flow chart illustrating an auto-editing process according to one embodiment of the present invention;

FIGS. 4-6 illustrate exemplary web pages that may be used to present results of an auto-editing process to an owner of the edited video item and for enabling the owner to perform advance editing on one or more alternate versions of the video item according to one embodiment of the present invention;

FIG. 7 illustrates a system wherein video items shared via a video sharing system are automatically edited according to a second embodiment of the present invention;

FIG. 8 illustrates the operation of the system of FIG. 7 according to one embodiment of the present invention;

FIG. 9 illustrates a system wherein video items are automatically edited in a peer-to-peer (P2P) video sharing environment according to a third embodiment of the present invention;

FIG. 10 illustrates the operation of the system of FIG. 9 according to one embodiment of the present invention;

FIG. 11 is a block diagram of the video sharing system of FIGS. 1 and 7 according to one embodiment of the present invention;

FIG. 12 is a block diagram of one of the user devices of FIGS. 1, 7, and 9 according to one embodiment of the present invention;

FIG. 13 illustrates a computing device operating to perform auto-editing on a video item according to one embodiment of the present invention; and

FIG. 14 is a block diagram of the computing device of FIG. 13 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

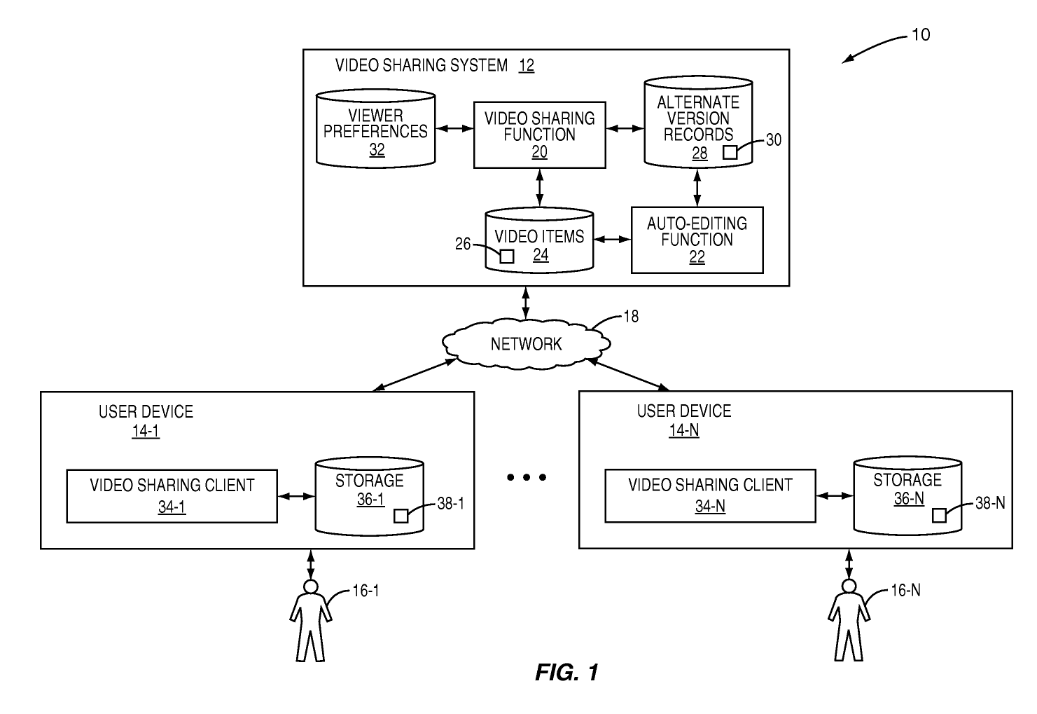

FIG. 1 illustrates a system 10 wherein video items shared via a video sharing system 12 are automatically edited according to one embodiment of the present invention. In general, the system 10 includes the video sharing system 12 and a number of user devices 14-1 through 14-N having associated users 16-1 through 16-N. The video sharing system 12 and the user devices 14-1 through 14-N are connected via a network 18. The network 18 may be any type of Wide Area Network (WAN) or Local Area Network (LAN), or any combination thereof, and may include wired components, wireless components, or both wired and wireless components.

The video sharing system 12 may be implemented as, for example, a single server, a number of distributed servers operating in a collaborative fashion, or the like. The video sharing system 12 includes a video sharing function 20 and an auto-editing function 22, each of which may be implemented in software, hardware, or a combination thereof. In addition, the video sharing system 12 includes a collection of video items 24 including a number of video items 26 shared by the users 16-1 through 16-N, which are hereinafter referred to as shared video items 26. The video sharing system 12 also includes a collection of alternate version records 28 including one or more alternate version records 30 for each of the shared video items 26 and viewer preferences database 32 of the users 16-1 through 16-N.

The collection of alternate version records 28 of the shared video items 26 includes one or more alternate version records 30 for each of the shared video items 26 resulting from an auto-editing process performed by the auto-editing function 22, as discussed below. Note that, in an alternative embodiment, the video sharing system 12 may store the alternate version records 30 of the shared video items 26 generated as a result of the auto-editing process. In general, each alternate version record 30 represents an alternate version of a corresponding shared video item 26 and includes proposed edits defining the alternate version of the corresponding shared video item 26. In one embodiment, each alternate version record 30 defines a manner in which playback of the corresponding shared video item 26 is to be controlled to provide the alternate version of the shared video item 26 represented by the alternate versions record 30. The alternate version records 30 may define segments of the shared video item 26 to be skipped or, conversely, segments of the shared video item 26 that are to be played in order to provide the alternate version 30 of the shared video item 26. In addition, the alternate version record 30 may include information defining one or more time periods in which an audio component of the shared video item 26 is to be muted during playback in order to, for example, mute profanity. Still further, the alternate version record 30 may include information defining one or more locations within playback of the alternate version of the shared video item 26 in which advertisements are to be inserted.

The viewer preferences database 32 include, for each user of the users 16-1 through 16-N, viewer preferences to be used when sharing video items with that user. Thus, using the user 16-1 as an example, the viewer preferences of the user 16-1 may include, for example, one or more preferred Motion Pictures Association of America (MPAA) ratings, one or more disallowed MPAA ratings, information identifying a desired aggressiveness for objectionable content filtering, information identifying a desired aggressiveness for undesirable or low value content filtering, information identifying one or more types of objectionable content to be filtered from video items shared with the user 16-1, information identifying one or more types of undesirable or low value content to be filtered from video items shared with the user 16-1, or the like. Still further, the viewer preferences for the user 16-1 may vary depending on a time of day, day of the week, or the like. In one embodiment, the viewer preferences are defined by the users 16-1 through 16-N. The viewer preferences may additionally or alternatively be inferred from actions taken by the users 16-1 through 16-N. For example, the viewer preferences of the user 16-1 may be inferred from the MPAA ratings of video items viewed by the user 16-1, objectionable content within segments of video items skipped over or fast-forwarded through by the user 16-1, undesirable content within segments of video items skipped over or fast-forwarded through by the user 16-1, or the like.

Each of the user devices 14-1 through 14-N may be, for example, a personal computer, a set-top box, a mobile telephone such as a mobile smart phone, a portable media player similar to an Apple® iPod® having network capabilities, or the like. The user device 14-1 includes a video sharing client 34-1 and a storage device 36-1 for storing one or more video items 38-1. The video sharing client 34-1 may be implemented in software, hardware, or a combination thereof. For example, the video sharing client 34-1 may be an Internet browser. As another example, the video sharing client 34-1 may be a proprietary software application. As discussed below, the video sharing client 34-1 enables the user 16-1 to share one or more of the video items 38-1 stored in the storage device 36-1 and provides playback of the alternate versions 30 of the shared video items 26 hosted by the video sharing system 12 under the control of the user 16-1. The storage device 36-1 is local storage of the user device 14-1 and may be implemented as, for example, internal memory, a removable memory card, a hard-disk drive, or the like. The video items 38-1 are preferably user-generated video items. Still further, the video items 38-1 are preferably user-generated video items created by, and therefore owned by, the user 16-1. However, the present invention is not limited thereto. Like the user device 14-1, the user devices 14-2 through 14-N include video sharing clients 34-2 through 34-N and storage devices 36-2 through 36-N storing video items 38-1 through 38-N, respectively.

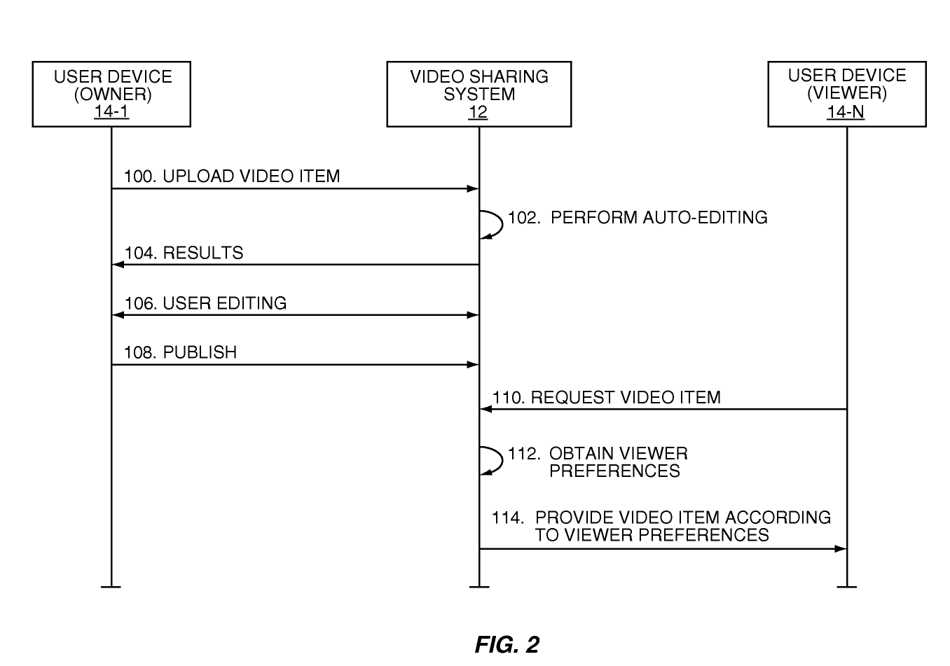

FIG. 2 illustrates the operation of the system 10 of FIG. 1 according to one embodiment of the present invention. First, in this example, the user 16-1 interacts with the video sharing client 34-1 of the user device 14-1 to upload one of the video items 38-1 from the storage device 36-1 of the user device 14-1 to the video sharing system 12 (step 100). The video sharing function 20 of the video sharing system 12 then stores the uploaded video item 38-1 from the user device 14-1 as a shared video item 26. Note that the user 16-1 is also referred to herein as the owner of that shared video item 26. Also note that the user 16-1 may be required to register with the video sharing system 12 via the video sharing client 34-1 prior to uploading the video item 38-1 to be shared by the video sharing system 12. During registration, the user 16-1 may define one or more viewer preferences to be used when the user 16-1 is viewing shared video items 26 shared by the other users 16-2 through 16-N.

Next, the video sharing system 12 performs an auto-editing process on the shared video item 26 uploaded by the user 16-1 (step 102). In one embodiment, the auto-editing function 22 of the video sharing system 12 performs an auto-editing process on the shared video items 26 in the collection of shared video items 24. The order in which the shared video items 26 are processed by the auto-editing function 22 may be based on priorities assigned to the shared video items 26. A priority may be assigned to a shared video item 26 based on one or more criteria such as, for example, system resource cost to analyze the shared video item 26, which may be based on a data size or playback length of the shared video item 26; a user subscription type (e.g., free user, premium user, commercial entity, etc.) where different priorities are assigned to users of different subscription types; projected savings in bandwidth to deliver alternate versions of the shared video items 26 as compared to delivering the shared video items 26, projected income from advertisements inserted into or presented in association with the shared video item 26, revenue derived from previous video items shared by the owner of the shared video item 26, revenue from shared video items 26 previously shared by the owner of the shared video item 26 and/or other users in a social network of the owner of the shared video item 26 through, for example, advertisements during playback of the previously shared video items 26; a number of playbacks of or requests for shared video items 26 previously shared by the owner of the shared video item 26 and/or other users in a social network of the owner of the shared video item 26; a size of a social network of the owner of the shared video item 26; number of MPAA rating mismatches between MPAA ratings desired by viewers of the shared video items 26 and the MPAA ratings of the shared video items 26; maximizing profit to an operator of the video sharing system 12, or the like.

As discussed below, the auto-editing function 22 generally operates to identify objectionable content in the shared video item 26 such as profanity, violence, nudity, or the like. In addition or alternatively, the auto-editing function 22 may identify undesirable or low value content in the shared video item 26. In general, the undesirable content is content within the shared video item 26 that is undesirable or of low value to all viewers or at least substantially all viewers. For example, the undesirable content may be a long zoom sequence, a quick zoom sequence, a long pan sequence, a quick pan sequence, a long gaze sequence, a quick glance sequence, a shaky sequence, and a sequence having essentially no activity. A long zoom sequence is a segment of the shared video item 26 where, during recording, the user recording the shared video item 26 steadily zoomed in or zoomed out for greater than a threshold amount of time. A quick zoom sequence is a segment of the shared video item 26 where the user recording the shared video item 26 zoomed in or zoomed out at greater than a threshold rate. A long pan is a segment of the shared video item 26 where the user recording the shared video item panned up, down, left, right, or the like for greater than a threshold amount of time. A quick pan is where the user recording the shared video item 26 panned at a rate greater than a threshold rate. A long gaze sequence is where the user recording the shared video item 26 fixed on an object or scene for greater than a threshold amount of time and, optionally, where there is essentially no activity. A quick glance is where the user recording the shared video item 26 quickly glanced at an object or scene and, optionally, there is essentially no activity. A shaky sequence is a sequence where the user recording the shared video item 26 was shaking more than a threshold amount. A sequence having essentially no activity is a segment of the shared video item 26 where there is essentially no visual and, optionally, essentially no audio activity. An example of a sequence having essentially no activity is where the user recording the shared video item 26 accidentally recorded while directing the video camera towards the ground.

Once segments of the shared video item 26 corresponding to objectionable and/or undesirable content are identified, the auto-editing function 22 generates alternate version records 30 defining one or more alternate versions of the shared video item 26. Again, the alternate version records 30 generally represent the alternate versions of the shared video item 26 and include proposed edits to the shared video item 26 defining the alternate versions of the shared video item 26. As discussed above, in one embodiment, the alternate version records 30 are used to control playback of the shared video item 26 in such a manner as to provide the alternate versions of the shared video item 26. In one embodiment, the alternate version records 30 are generated according to the Synchronized Multimedia Integration Language (SMIL) markup language. For example, based on the objectionable content identified for the shared video item 26, the shared video item 26 may be assigned an MPAA rating of R. As such, the auto-editing function 22 may generate alternate version records 30 including proposed edits defining one or more PG-13 versions of the shared video item 26, one or more PG versions of the shared video item 26, one or more G versions of the shared video item 26, or the like by filtering some or all of the objectionable content from the shared video item 26 depending on the particular alternate version. Once the alternate version records 30 are generated, the results of the auto-editing process may be presented to the user 16-1 (step 104). The results generally include the proposed edits or information describing the proposed edits to the shared video item 26 for each of the one or more alternate versions. For example, the results may enable the user 16-1 to view each of the alternate versions, view objectionable content and/or undesirable content filtered from the shared video item 26 for each of the alternate versions, view a description of objectionable content and/or undesirable content filtered from the shared video item 26 for each of the alternate versions, or the like.

At this point, the user 16-1 may be enabled to select one or more of the alternate versions and further edit the selected alternate versions, and more specifically the proposed edits contained in the alternate version records 30 representing the selected alternate versions, as desired (step 106). For example, the user 16-1 may be enabled to adjust an aggressiveness of objectionable content filtering for a selected alternate version, adjust an aggressiveness of undesirable content filtering for a selected alternate version, select additional objectionable content to filter from the shared video item 26 for a selected alternate version, select additional undesirable content to filter from the shared video item 26, or the like. The user 16-1 then selects one or more of the alternate versions of the shared video item 26 to publish (step 108). The published alternative versions of the shared video item 26 are then made available by the video sharing system 12 for sharing with the other users 16-2 through 16-N.

At some time thereafter, in response to user input from the user 16-N, the user device 16-N, and more specifically the video sharing client 34-N, sends a request to the video sharing system 12 for the shared video item 26 shared by the user 16-1 (step 110). When requesting and subsequently viewing the shared video item 26, the user 16-N is also referred to herein as a viewer. Note that the request may be a general request for the shared video item 26, where the video sharing function 20 subsequently selects one of the alternate versions of the shared video item 26 that have been published to return to the user 16-N based on the viewer preferences of the user 16-N. Alternatively, the user 16-N may be enabled to select the desired alternate version of the shared video item 26, in which case the request would be a request for the desired alternate version of the shared video item 26.

In this embodiment, in response to the request, the video sharing function 20 of the video sharing system 12 obtains the viewer preferences of the user 16-N from the viewer preferences 32 (step 112). As mentioned above, in one embodiment, the request is a general request for the shared video item 26. As such, the video sharing function 20 selects one of the published alternate versions of the shared video item 26 to share with the user 16-N based on the viewer preferences of the user 16-N. For example, in one embodiment, each of the published alternate versions of the shared video item 26 is assigned an MPAA rating. In addition, the viewer preferences of the user 16-N may identify a desired or preferred MPAA rating such as PG-13. As such, the video sharing function 20 may select the alternate version of the shared video item 26 having a MPAA rating of PG-13. If multiple alternate versions are assigned a PG-13 rating, the video sharing function 20 may randomly select one of the alternate versions having a PG-13 rating, select one of the alternate versions having a PG-13 rating based on additional viewer preferences of the user 16-N, select one of the alternate versions most preferred or viewed by other users, or the like. The additional viewer preferences may be, for example, types of objectionable content that the user 16-N desires to be filtered as compared to the types of objectionable content that have been filtered or that remain in the alternate versions, desired aggressiveness of objectionable and/or undesirable content filtering for the user 16-N as compared to that used for the alternate versions of the shared video item 26, or the like. In another embodiment, the request identifies the desired alternate version of the shared video item 26 to be delivered to the user 16-N at the user device 14-N.

In addition or as an alternative to the viewer preferences of the user 16-N, the video sharing function 20 may consider access rights granted to the user 16-N, a relationship between the users 16-1 and 16-N, or the like when selecting the alternate version of the shared video item 26 to be shared with the user 16-N. For example, in one embodiment, the user 16-1 may publish one version of the shared video item 26 to be shared with a group of the other users 16-2 through 16-N identified as friends of the user 16-1 and another version of the shared video item 26 to be shared with a group of the other users 16-2 through 16-N identified as family members of the user 16-1.

The video sharing function 20 of the video sharing system 12 then provides the selected alternate version of the shared video item 26 to the user device 14-N (step 114). In this example, the video sharing function 20 provides the selected alternate version of the shared video item 26 according to the viewer preferences of the user 16-N. More specifically, in one embodiment, the alternate versions of the shared video item 26 are represented by the alternate version records 30, as discussed above. The alternate version record 30 for the selected alternate version of the shared video item 26 is then applied to the shared video item 26 by the video sharing function 20 to provide the alternate version of the shared video item 26. For example, the video sharing function 20 may stream the shared video item 26 to the user device 14-N according to the alternate version record 30 for the selected alternate version of the shared video item 26, thereby providing the selected alternate version of the shared video item 26. Alternatively, the shared video item 26 and the alternate version record 30 for the selected alternate version of the shared video item 26 may be provided to the user device 14-N. The video sharing client 34-N of the user device 14-N may then provide playback of the shared video item 26 according to the alternate version record 30, thereby providing the alternate version of the shared video item 26.

In addition, as discussed below, the viewer preferences of the user 16-N may be further utilized when providing the selected version of the shared video item 26 to the user 16-N of the user device 14-N. More specifically, in one embodiment, data is stored by the video sharing system 12 identifying the objectionable content and/or undesirable content in the shared video item 26. Thus, when providing the selected alternate version of the shared video item 26 to the user device 14-N, the alternate version may be further modified according to the viewer preferences of the user 16-N. For example, if only a portion of the objectionable content has been filtered for the selected alternate version and the user 16-N has defined viewer preferences indicating that the user 16-N desires for all nudity or sexual situations and all long zooms (i.e., zooming in or out more than a determined threshold) to be filtered, the video sharing function 20 may further modify the alternate version of the shared video item 26 such that any remaining nudity or sexual situations and any long zooms are filtered when the selected alternate version is shared with the user 16-N. Since this objectionable and/or undesirable content has already been identified, the further modification of the selected alternate version of the shared video item 26 can be easily achieved. In one embodiment, the alternate version record 30 for the selected alternate version may be modified based on the viewer preferences of the user 16-N to provide a modified alternate version record. As discussed above, the modified alternate version record may then be used to stream the selected alternate version of the shared video item 26 to the user device 14-N. Alternatively, the shared video item 26 and the modified alternate version record may be provided to the user device 14-N, where the video sharing client 34-N then provides playback of the shared video item 26 according to the modified alternate version record.

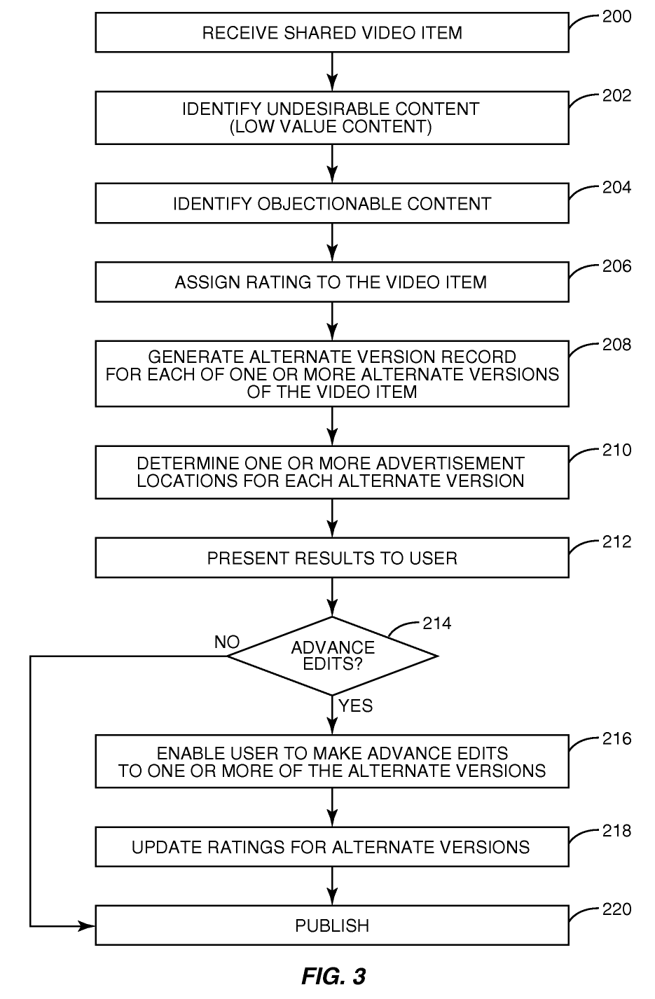

FIG. 3 is a flow chart illustrating the operation of the auto-editing function 22 of FIG. 1 according to one embodiment of the present invention. First, the auto-editing function 22 receives a shared video item 26 or otherwise obtains the shared video item 26 from the collection of video items 24 (step 200). Again, note that the auto-editing of the shared video items 26 in the collection of video items 24 shared by the users 16-1 through 16-N may be prioritized, as discussed above. In this embodiment, the auto-editing function 22 then identifies undesirable or low value content in the shared video item 26 (step 202). More specifically, in one embodiment, metadata for the shared video item 26 is stored within or in association with the corresponding video file where the metadata includes information from a corresponding video capture device used to record the shared video item 26 such as, for example, focal length of the video capture device, information from a light sensor of the video capture device, information from an accelerometer of the video capture device, or the like. Based on the metadata, the auto-editing function 22 identifies undesirable content in the shared video item 26.

For instance, based on the information identifying the focal length of the video capture device while recording the shared video item 26, the auto-editing function 22 may identify segments of the shared video item 26 during which a long zoom occurred or a quick zoom occurred as undesirable content. As used herein, long zoom refers to the situation where the user recording the shared video item 26 steadily zooms in or out for at least a threshold amount of time. In contrast, quick zoom refers to the situation where the user recording the shared video item 26 zooms in or out at a rate greater than a threshold rate.

The information from the light sensor may be utilized to identify segments of the shared video item 26 captured in lighting conditions above an upper light threshold, below a lower light threshold, or the like. Thus, in other words, segments of the shared video item 26 captured in bright lighting conditions may be identified as undesirable content. Similarly, segments of the shared video item 26 captured in low light conditions may also be identified as undesirable content. These identified segments may be identified as undesirable content of the shared video item 26.

The information from the accelerometer may be utilized to identify segments of the shared video item 26 where, during recording of those segments, the user recording the shared video item 26 quickly moved the video capture device (e.g., quickly panned, up, down, left, right, or the like) based on a threshold rate of change. The information from the accelerometer may also be utilized to identify segments of the shared video item 26 where, during recording of these segments, the user recording the shared video item 26 was shaking more than a threshold amount. These types of identified segments may also be identified as undesirable content.

Note that the content of some or all of the segments of the shared video content identified based on the metadata as undesirable content may additionally be analyzed before finally determining that the segments contain undesirable content using traditional video analysis techniques such as, for example, entropy checking. More specifically, a threshold entropy value may be experimentally determined. Then, for a particular segment to be analyzed, an average entropy value may be determined and compared to the threshold entropy value. From this comparison, a determination is made as to whether the segment is to be classified as undesirable content.

Also, the information identifying the focal length of the video capture device and the information from the accelerometer may be combined to identify segments of the shared video item 26 where, during recording of those segments, the user recording the shared video item 26 was fixed on a particular object or scene or quickly glanced to an object or scene. In either of those cases, the auto-editing function 22 may further process the content of the shared video item 26 during those segments to determine whether there is little or no activity. If there is little or no activity in any of these segments, then the segments having little or no activity may be identified undesirable content.

In addition to identifying the undesirable content, in this example, the auto-editing function 22 identifies objectionable content in the shared video item 26 (step 204). In this embodiment, the shared video items 26 are user-generated videos such as those shared via video sharing services such as YouTube. Thus, in order to identify the objectionable content, the audio content, the visual content, or both the audio and visual content of the shared video item 26 are preferably analyzed. More specifically, in one embodiment, the auto-editing function 22 processes an audio component, or audio content, of the shared video item 26 to identify objectionable audio content and, optionally, identify cues indicating that there may be corresponding objectionable visual content. The audio content may be processed by comparing the audio content of the shared video item 26 to one or more predefined reference audio segments. For example, for each of a number of terms or phrases defined as profanity, a corresponding reference audio segment may be compared to the audio content of the shared video item 26 to identify instances of the profane term or phrase in the shared video item 26. Alternatively, speech-to-text conversion may be performed on the audio component and the resulting text may be compared to a list of one or more keywords or phrases defined as objectionable content in order to identify objectionable content such as profanity. In a similar fashion, the audio component of the shared video item 26 may be analyzed to identify cues indicating that the corresponding visual content of the shared video item 26 may be objectionable content. For example, if violence is to be identified as objectionable content, the audio content of the shared video item 26 may be analyzed to identify gun shots, explosions, or the like.

In addition to processing the audio content of the shared video item 26, the auto-editing function 22 may analyze the visual content of the shared video item 26. More specifically, in one embodiment, a number of predefined reference visual segments or rules are compared to the visual content of the shared video item 26 in order to identify objectionable content such as violence, nudity, and the like. In addition, as verification, for at least some types of objectionable visual content, the auto-editing function 22 may confirm that a corresponding cue was identified in the audio content of the shared video item 26. For example, for an explosion, the auto-editing function 22 may confirm that a sound or sounds consistent with an explosion, and thus identified as a cue, were identified at a corresponding point in playback of the audio component of the shared video item 26. Alternatively, any cues identified in the audio content may be used to identify segments of the visual content to be analyzed for objectionable content.

In addition or as an alternative to analyzing the audio and visual content of the shared video item 26 to identify objectionable content, the objectionable content may be identified based on comments or annotations provided by an owner of the shared video item 26, one or more previous viewers of the shared video item, or the like. Likewise, such comments or annotations may also be used to identify undesirable content.

In this example, the auto-editing function 22 then assigns an MPAA rating to the shared video item 26 based on the objectionable content identified in step 204 (step 206). More specifically, using one or more predefined rules, the auto-editing function 22 assigns an MPAA rating (e.g., NC-17, R, PG-13, PG, or G) to the shared video item 26 based on the objectionable content identified in step 204. The one or more predefined rules may consider the number of instances of objectionable content, a type of each instance of objectionable content (e.g., profanity, violence, nudity, sexual situations, etc.), a duration of each instance of the objectionable content, or the like. For example, each rule may have an associated point value. If the rule is satisfied, a rating score assigned to the shared video item 26 is incremented by the point value for that rule. Once the analysis is complete, an MPAA rating is assigned based on the final rating score assigned to the shared video item 26. As an example, a rule may provide that if there are five or more instances of sexually-oriented nudity, a rating score for the shared video item 26 is to be incremented by eight (8) points. The MPAA rating may then be assigned based on the final rating score using the following exemplary scale:

rating score: 0 MPAA rating: G

rating score: 1-3 MPAA rating: PG

rating score: 4-7 MPAA rating: PG-13

rating score: 8-10 MPAA rating: R

rating score: 11+ MPAA rating: NC-17.

Once the MPAA rating has been assigned, the auto-editing function 22 generates alternate version records 30 for one or more alternate versions of the shared video item 26 (step 208). More specifically, in the preferred embodiment, one or more rules, or auto-editing rules, are defined for generating the one or more alternate versions. The alternate version record 30 for each of the one or more alternate versions is generated based on the one or more rules. For each alternate version, the one or more rules defining the alternate version may define an aggressiveness of objectionable content filtering, an aggressiveness of undesirable content filtering, an aggressiveness of objectionable content filtering for each of a number of types of objectionable content, an aggressiveness of undesirable content filtering for each of a number of types of undesirable content, one or more types of objectionable content and/or undesirable content to be replaced with alternative content, a number of advertisements to be inserted into the alternate version, or the like. Note that, as used herein, filtering includes removing objectionable or undesirable content from the shared video item 26. The objectionable or undesirable content may be removed by removing a segment of the shared video item 26 including the objectionable or undesirable content. Note, however, for some types of objectionable content, the objectionable content may otherwise be removed. For example, for profanity, the profanity may be removed by removing a corresponding segment of the shared video item 26 or by muting a corresponding segment of an audio component of the shared video item 26.

The aggressiveness of the objectionable content filtering may define a number or percentage of objectionable content instances to be filtered from the shared video item 26 or a number or percentage of objectionable content instances permitted to remain in the shared video item 26. If numbers are used, the number of objectionable content instances to be filtered or permitted to remain may be any number from zero (0) to a total number of instances in the shared video item 26. Similarly, if percentages are used, the percentage of objectionable content instances to be filtered or permitted to remain may be any percentage from 0% to 100%. Likewise, the aggressiveness of the objectionable content filtering for a particular type of objectionable content (e.g., violence, nudity, profanity, etc.) may define a number or percentage of objectionable content instances of that type to be filtered from the shared video item 26 or a number or percentage of objectionable content instances of that type permitted to remain in the shared video item 26.

Similarly, the aggressiveness of the undesirable content filtering may define a number or percentage of undesirable content instances to be filtered from the shared video item 26 or a number or percentage of undesirable content instances permitted to remain in the shared video item 26. If numbers are used, the number of undesirable content instances to be filtered or permitted to remain may be any number from zero (0) to a total number of instances in the shared video item 26. Similarly, if percentages are used, the percentage of undesirable content instances to be filtered or permitted to remain may be any percentage from 0% to 100%. Likewise, the aggressiveness of the undesirable content filtering for a particular type of undesirable content (e.g., long zoom, quick zoom, quick pan, shaky, low-light, bright-light, etc.) may define a number or percentage of undesirable content instances of that type to be filtered from the shared video item 26 or a number or percentage of undesirable content instances of that type permitted to remain in the shared video item 26.

Note that while the aggressiveness of the objectionable content filtering and the aggressiveness of the undesirable content filtering have been discussed above as being defined by numbers or percentages, the present invention is not limited thereto. For example, the aggressiveness of the objectionable content filtering may be defined by a severity setting, which may be represented as a maximum or threshold playback length or duration of an instance of objectionable content. Instances of objectionable content having playback lengths or durations greater than the threshold are filtered. The same may be used for defining the aggressiveness of the undesirable content filtering. As an example, two unstable and unfocused instances may be detected as undesirable content instances in a video item. One of the instances is 9 seconds long and the other is 3 seconds long. If the user has defined the aggressiveness of the undesirable content filtering to “allow <5 seconds”, the 9 second instance is filtered and the 3 second sequence is not filtered.

Similarly, the aggressiveness of the undesirable content filtering may be defined by a severity setting defining a threshold undesirable content intensity. For example, two low-light segments of the video item may be identified as instances of undesirable content. One of the instances is drastically underexposed, the other is underexposed but still readable. Then, based on the threshold, the drastically underexposed instance may be filtered and the other instance may not be filtered.

The rules may define one or more types of objectionable content to be replaced with alternate content. For example, profanity may be replaced with a “beep” or replaced with alternative audio content such as another word or phrase. As another example, one or more instances of violence may be replaced with an advertisement such as an audio/visual advertisement, a visual advertisement where the corresponding audio content of the shared video item 26 may be muted, a black screen where the corresponding audio content of the shared video item 26 may be muted, or the like. Note that when replacing objectionable content with an advertisement, the alternate version record 30 representing the alternate version of the shared video item 26 may include the advertisement or a reference to the advertisement such as, for example, a Uniform Resource Locator (URL). Likewise, the rules defining the alternate version may define one or more types of undesirable content to be replaced with alternative content such as, for example, advertisements.

As an example of replacing objectionable content and/or undesirable content with an advertisement, the one or more rules defining an alternate version of the shared video item 26 may state that 1 out of every 3 instances of violence are to be filtered from the shared video item 26. The rules may further state that one or more of the filtered instances of violence are to be replaced with an advertisement. Alternatively, the rules may state one or more of the remaining instances of violence in the alternate version of the shared video item 26 are to be replaced with an advertisement. For each advertisement location, the video sharing system 12 may statically define one or more advertisements for the advertisement location. Alternatively, the video sharing system 12 may dynamically update the one or more advertisements for the advertisement location using any desired advertisement placement technique.

The rules defining the alternate version of the shared video item 26 may also include information defining whether advertisements are to be inserted into the shared video item 26 for the alternate version. If so, the rules may also define a maximum number of advertisements to be inserted, a minimum number of advertisements to be inserted, or both.

In this example, advertisements are to be inserted into the alternate versions of the shared video item 26. These advertisements are in addition to any advertisements inserted to replace objectionable content or undesirable content. As such, the auto-editing function 22 determines one or more advertisement locations in which advertisements are to be inserted for each alternate version (step 210). The advertisement locations may be determined using any desired technique. For example, the advertisement locations may be one or more scene transitions detected in the shared video item 26. The scene transitions may be identified based on motion, where it is assumed that there is little or no motion at a scene change. Alternatively, all black frames may be detected as scene transitions. Note that, in addition to the advertisement locations determined in step 210, additional advertisement locations may be determined in step 208 when generating the one or more alternate versions of the shared video item 26, as discussed above. The advertisement locations and, optionally, advertisements or references to advertisements to be inserted into the advertisement locations are then added to the corresponding alternate version records 30.

At this point, the results of the auto-editing process performed in steps 200-210 are presented to the user 16-1 (step 212). The results of the auto-editing process generally include the proposed edits for each of the alternate versions of the shared video item 26 or information describing the proposed edits for each of the alternate versions of the shared video item 26. For example, the results presented to the user 16-1 may include, for example, a listing of the alternate versions generated, an MPAA rating for each of the alternate versions, a description of the objectionable content and/or undesirable content filtered from the shared video item 26 for each alternate version, information identifying each instance of objectionable content and/or undesirable content filtered from the shared video item 26 for each alternate version, information identifying advertisement locations in each of the alternate versions, or the like. In one embodiment, the results of the auto-editing process of steps 200-210 are presented to the user 16-1 via a web page or series of web pages. However, the present invention is not limited thereto. Note that, in one embodiment, the user 16-1 may be notified via, for example, e-mail, instant messaging, text-messaging, or the like when the auto-editing process of steps 200-210 is complete. The notification may include a URL link to a web page containing the results of the search. In addition, user input mechanisms may be provided in association with the results to enable the user 16-1 to perform advance editing on one or more of the alternate versions, as desired. Still further, user input mechanisms may be provided in association with the results to enable the user 16-1 to select one or more of the alternate versions to be published, or shared, with the other users 16-2 through 16-N. Note that the user 16-1 may also be enabled to define access rights for each alternate version published. For example, for each alternate version published, the user 16-1 may be enabled to define one or more users or groups of users who are permitted to view that alternate version, one or more users or groups of users who are not permitted to view that alternate version, or the like.

Next, the auto-editing function 22 determines whether the user 16-1 has chosen to perform advance edits on one or more of the alternate versions of the shared video item (step 214). If not, the user 16-1 has chosen to accept the proposed edits generated by the auto-editing function 22, and the process proceeds to step 220, which is discussed below. If the user 16-1 has chosen to perform advance editing, the auto-editing function 22 enables the user 16-1 to perform advance editing on one or more alternate versions of the shared video item 26 selected by the user 16-1 (step 216). The advance editing may be, for example, reviewing and modifying advertisement locations, modifying the advertisement or advertisement type to be inserted into one or more advertisement locations, adjusting an aggressiveness of objectionable content filtering, adjusting an aggressiveness of undesirable content filtering, selecting objectionable content that has been filtered that is to be reinserted, selecting objectionable content that has not been filtered that is to be filtered, selecting undesirable content that has been filtered that is to be reinserted, selecting undesirable content that has not been filtered that is to be filtered, selecting additional segments of the shared video item 26 that are to be filtered, or the like. Note that the rules for generating the one or more alternate versions of the shared video item 26 may identify one or more types of objectionable content that are not permitted and therefore not capable of being reinserted by the user 16-1.

Once advance editing is complete, the MPAA ratings of the one or more alternate versions may be updated if necessary using the procedure as discussed above with respect to step 206 (step 218). The user 16-1 then selects one or more of the alternate versions to publish (step 220). The alternate versions that are published are then shared by the video sharing system 12 with the other users 16-2 through 16-N. Note that while the exemplary process of FIG. 3 identifies both objectionable and undesirable content, the present invention is not limited thereto. The auto-editing process may identify and filter or replace instances of objectionable content, instances of undesirable content, or both instances of objectionable content and undesirable content.

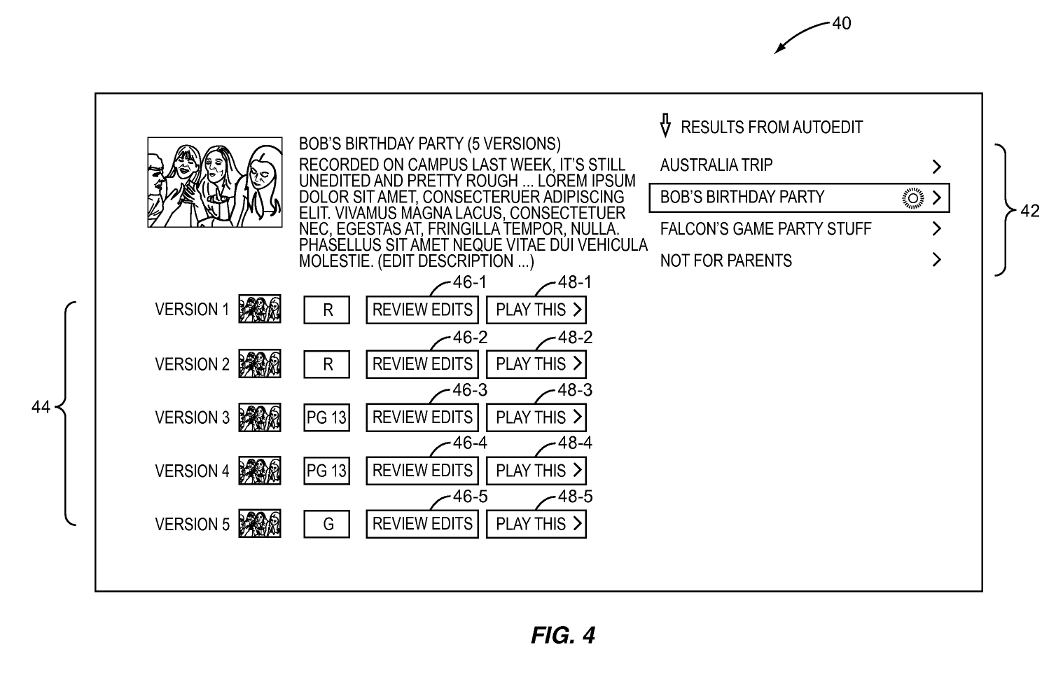

FIGS. 4-6 illustrate exemplary web pages that may be used to present the results of the auto-editing process to the user 16-1, enable the user 16-1 to perform advance editing, and enable the user 16-1 to select one or more of the alternate versions of the shared video item 26 to publish. FIG. 4 illustrates an initial results web page 40 that may first be presented to the user 16-1 when providing the results of the auto-editing process to the user 16-1. In this example, the initial results web page 40 includes a listing 42 of shared video items 26 shared by the user 16-1 that have been processed by the auto-editing function 22. The listing 42 is also referred to herein as shared video item listing 42. In this example, the user 16-1 has chosen to view the results of the shared video item 26 entitled “Bob's Birthday Party.” The initial results web page 40 also includes a listing 44 of the alternate versions of the shared video item 26 for which proposed edits have been generated by the auto-editing process. The listing 44 is also referred to herein as an alternate versions listing 44. In this example, proposed edits for five (5) alternate versions of “Bob's Birthday Party” have been generated. For each alternate version, the initial results web page 40 includes a brief description of the proposed edits, which in this example is the MPAA rating. In addition, the initial results web page 40 includes “review edits” buttons 46-1 through 46-5 enabling the user 16-1 to review the proposed edits to the shared video item 26 for the corresponding alternate versions if desired and “play this” buttons 48-1 through 48-5 enabling the user 16-1 to view the corresponding alternate versions of the shared video item 26 if desired.

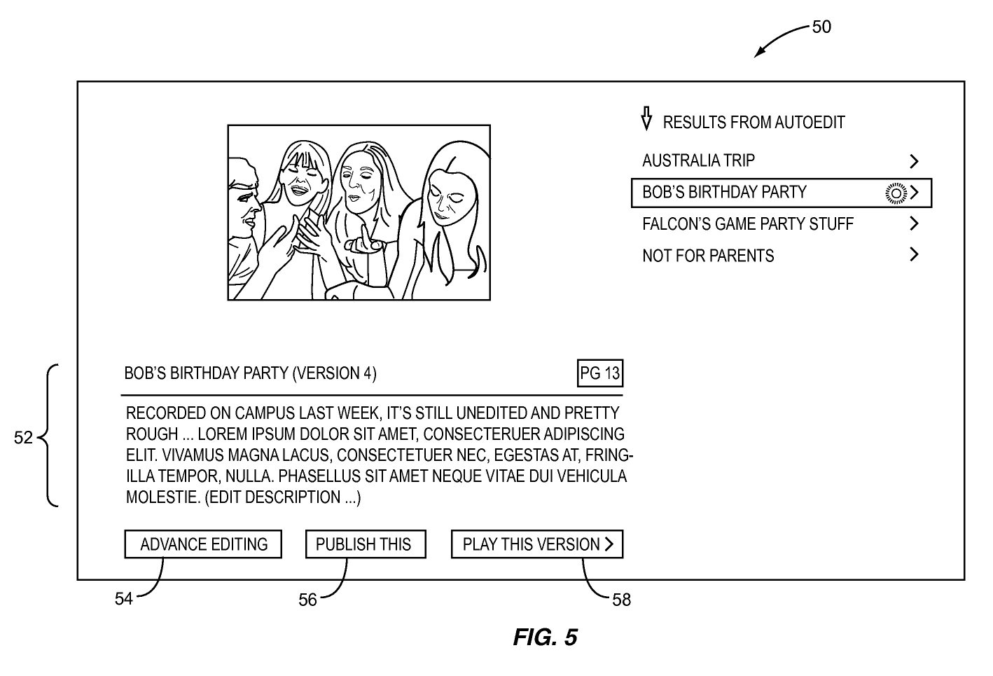

As illustrated in FIG. 5, if the user 16-1 chooses to review the edits for the fourth alternate version by selecting the “review edits” button 46-4 (FIG. 4), as an example, a second web page 50 may be presented to the user 16-1. The second web page 50 includes a description 52 of the alternate version of the shared video item 26. In addition or alternatively, the second web page 50 may include a brief text-based description of the proposed edits to the shared video item 26 for the alternate version. For example, information identifying the types of objectionable content and/or undesirable content that have been filtered, the amount of objectionable content and/or undesirable content that has been filtered, the number of advertisement locations, or the like may be provided. In addition, the second web page 50 includes an “advance editing” button 54 enabling the user 16-1 to choose to perform advance editing on the alternate version, a “publish this” button 56 enabling the user 16-1 to select the alternate version as one to be published, and a “play this version” button 58 enabling the user 16-1 to view the alternate version.

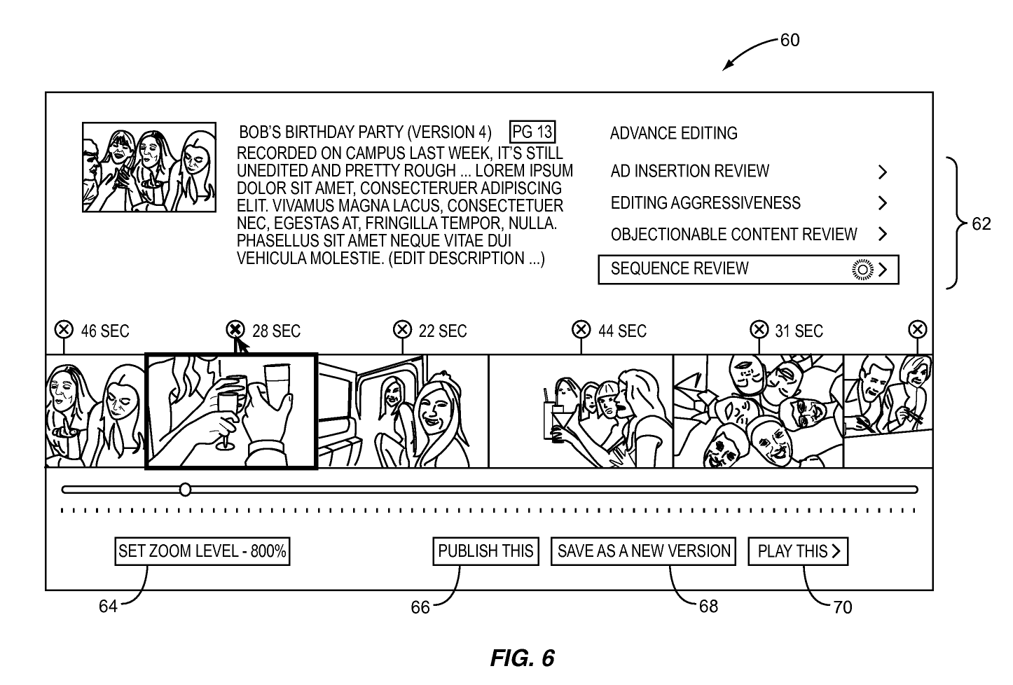

As illustrated in FIG. 6, if the user 16-1 chooses to perform advance editing for the fourth alternate version by selecting the “advance editing” button 54 (FIG. 5), a third web page 60 may be presented to the user 16-1. The third web page 60 includes a list 62 of advance editing options, which is also referred to herein as an advance editing options list 62. In this example, the advance editing options list 62 includes an advertisement (“ad”) insertion review option, an editing aggressiveness option, an objectionable content review option, and a sequence review option. The ad insertion review option enables the user 16-1 to view and modify the advertisement locations inserted into the shared video item 26 by the proposed edits for this alternate version and may additionally allow the user 16-1 to view and modify the advertisements or types of advertisements to be inserted into the advertisement locations. For example, the user 16-1 may be enabled to add new advertisement locations, delete advertisement locations, move advertisement locations, select new advertisements or advertisement types for the advertisement locations, or the like. The editing aggressiveness option enables the user 16-1 to view and modify an aggressiveness of objectionable content filtering and/or an aggressiveness of undesirable content filtering for this alternate version of the shared video item 26.

The objectionable content review option may enable the user 16-1 to view and modify the types of objectionable content filtered from the shared video item 26 by the proposed edits for this alternate version, view and modify objectionable content instances filtered from the shared video item 26 by the proposed edits for this alternate version, or the like. For example, the user 16-1 may be presented with a list of objectionable content types that have been completely or partially filtered by the proposed edits. The user 16-1 may then be enabled to add objectionable content types to the list, remove objectionable content types from the list, or the like. As another example, the user 16-1 may additionally or alternatively be presented with a listing of objectionable content instances in the shared video item 26 where the objectionable content instances that have been filtered or replaced by alternate content are identified. The user 16-1 may then select new objectionable content instances to be filtered, select new objectionable content instances to be replaced with alternate content such as advertisements, select objectionable content instances that have been filtered that are to be reinserted into the alternate version of the shared video item 26, select objectionable content instances that have been replaced with alternate content that are to be reinserted into the alternate version of the shared video item 26, or the like.

Lastly, in this example, the user 16-1 has selected the sequence review option. As illustrated, the sequence review option presents a list or sequence of segments of this alternate version of the shared video item 26. The user may then choose additional segments to be filtered or replaced by alternative content for this alternate version. Note that, via a “set zoom level” button 64, the user 16-1 can control a granularity of the segments shown in the sequence or list. The higher the zoom level, the smaller the segments. The lower the zoom level, the larger the segments. More specifically, as the zoom level increases, the time duration of each segment represented in the sequence or list decreases and vice versa.

In this example, the third web page 60 also includes a “publish this” button 66 that enables the user 16-1 to select this alternate version of the shared video item 26 as one to be published. The third web page 60 also includes a “save as a new version” button 68 which enables the user 16-1 to choose to save the edited alternate version as a new alternate version of the shared video item 26, thereby keeping the original alternate version. Lastly, the third web page 60 includes a “play this” button 70 which enables the user 16-1 to choose to play the edited alternate version of the shared video item 26.

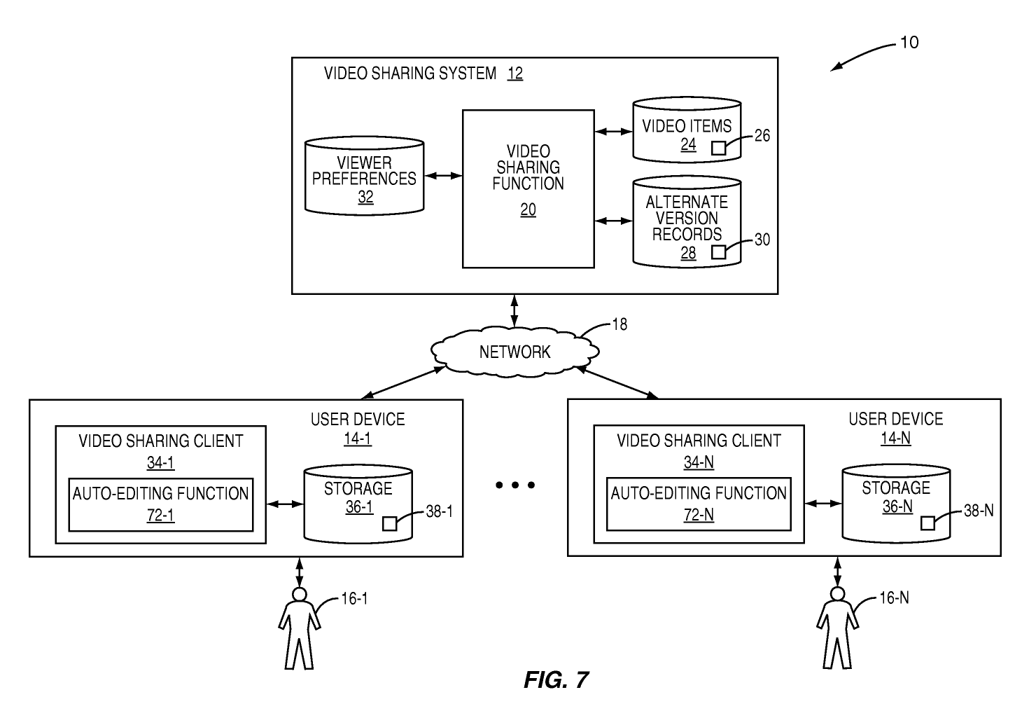

FIG. 7 illustrates the system 10 according to a second embodiment of the present invention that is substantially the same as that described above. However, in this embodiment, the auto-editing process is performed at the user devices 14-1 through 14-N. As illustrated, the video sharing system 12 of this embodiment does not include the auto-editing function 22. Rather, the video sharing clients 34-1 through 34-N of the user devices 14-1 through 14-N include auto-editing functions 72-1 through 72-N, respectively. The auto-editing functions 72-1 through 72-N operate to perform auto-editing at the user devices 14-1 through 14-N of the video items 38-1 through 38-N that are shared by the video sharing system 12. Note that, in yet another embodiment of the present invention, the auto-editing process may be performed in a collaborative fashion by the auto-editing functions 72-1 through 72-N at the user devices 14-1 through 14-N and the auto-editing function 22 of the video sharing system 12.

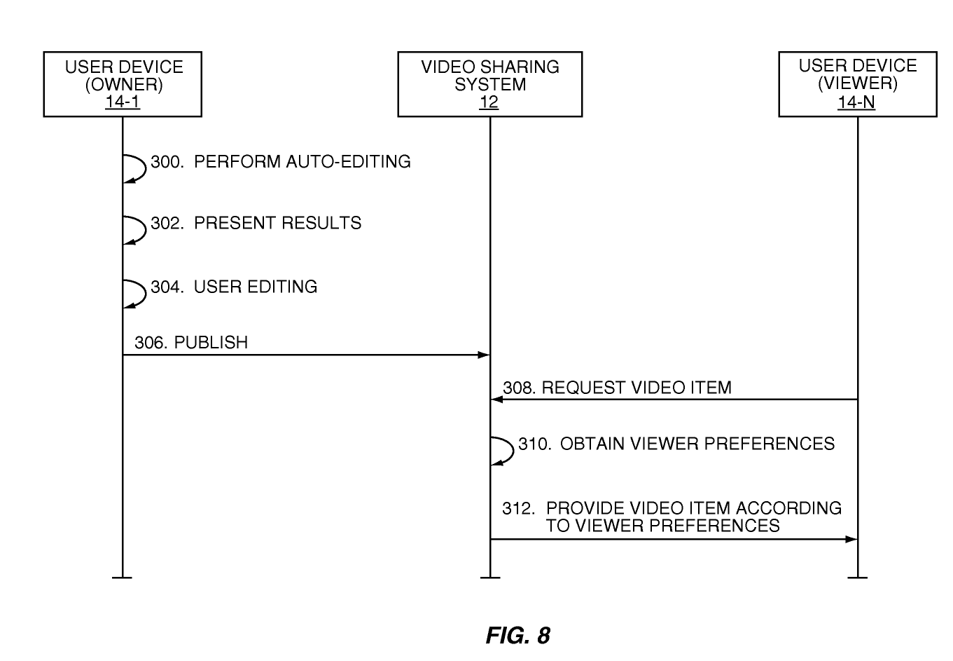

FIG. 8 illustrates the operation of the system 10 of FIG. 7 according to one embodiment of the present invention. First, the auto-editing function 72-1 of the video sharing client 34-1 of the user device 14-1 performs an auto-editing process on the video item 38-1 stored locally in the storage device 36-1 of the user device 14-1 (step 300). The auto-editing process may be performed before, during, or after the video item 38-1 has been uploaded to the video sharing system 12, stored as one of the shared video items 26, and optionally shared by the video sharing system 12. The auto-editing process performed by the auto-editing function 72-1 is the same as that performed by the auto-editing function 22 discussed above. As such, the details of the auto-editing process are not repeated. Results of the auto-editing process may then be presented to the user 16-1 (step 302), and the user 16-1 may then be enabled to perform advance editing if desired (step 304). The user 16-1 then selects one or more of the alternate versions resulting from the auto-editing process and any subsequent advance edits made by the user 16-1 to publish, and the selected alternate versions are then published (step 306). In the preferred embodiment, the alternate versions of the video item 38-1 are defined by the alternate version records 30, as discussed above. As such, the alternate version records 30 for the one or more alternate versions selected to publish are uploaded to the video sharing system 12 and stored in the collection of alternate version records 28.

At some time thereafter, in response to user input from the user 16-N, the user device 16-N, and more specifically the video sharing client 34-N, sends a request to the video sharing system 12 for the shared video item 26 corresponding to the video item 38-1 shared by the user 16-1 (step 308). When requesting and subsequently viewing the shared video item 26, the user 16-N is also referred to herein as a viewer. Note that the request may be a general request for the shared video item 26, where the video sharing function 20 subsequently selects one of the alternate versions of the shared video item 26 that have been published to return to the user 16-N based on the viewer preferences of the user 16-N. Alternatively, the user 16-N may be enabled to select the desired alternate version of the shared video item 26, in which case the request would be a request for the desired alternate version of the shared video item 26.

In this embodiment, in response to the request, the video sharing function 20 of the video sharing system 12 obtains the viewer preferences of the user 16-N from the viewer preferences 32 (step 310). As mentioned above, in one embodiment, the request is a general request for the shared video item 26. As such, the video sharing function 20 selects one of the published alternate versions of the shared video item 26 to share with the user 16-N based on the viewer preferences of the user 16-N. In another embodiment, the request identifies the desired alternate version of the shared video item 26 to be delivered to the user 16-N at the user device 14-N.

The video sharing function 20 of the video sharing system 12 then provides the selected alternate version of the shared video item 26 to the user device 14-N (step 312). In this example, the video sharing function 20 provides the selected alternate version of the shared video item 26 according to the viewer preferences of the user 16-N. More specifically, in one embodiment, the alternate versions of the shared video item 26 are defined by the alternate version records 30, as discussed above. The alternate version record 30 for the selected alternate version may be applied to the shared video item 26 by the video sharing function 20 to provide the alternate version of the shared video item 26. For example, the video sharing function 20 may stream the shared video item 26 to the user device 14-N according to the alternate version record 30 for the selected alternate version of the shared video item 26, thereby providing the selected alternate version of the shared video item 26. Alternatively, the shared video item 26 and the alternate version record 30 for the selected alternate version of the shared video item 26 may be provided to the user device 14-N. The video sharing client 34-N of the user device 14-N may then provide playback of the shared video item 26 according to the alternate version record 30, thereby providing the alternate version of the shared video item 26.

In addition, as discussed below, the viewer preferences may be further utilized when providing the selected version of the shared video item 26 to the user 16-N of the user device 14-N. More specifically, in one embodiment, data is stored by the video sharing system 12 identifying the objectionable content and/or undesirable content in the shared video item 26. Thus, when providing the selected alternate version of the shared video item 26 to the user device 14-N, the alternate version may be further modified according to the viewer preferences of the user 16-N.

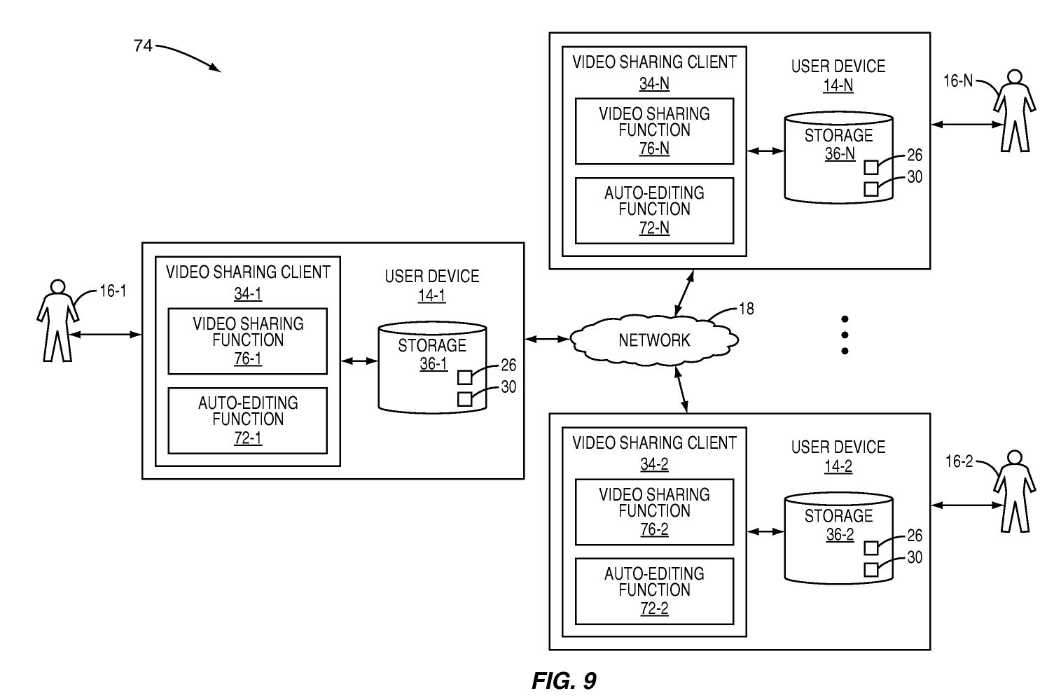

FIG. 9 illustrates a system 74 according to a third embodiment of the present invention wherein the user devices 14-1 through 14-N share video items in a peer-to-peer (P2P) fashion. The system 74 generally includes the user devices 14-1 through 14-N connected via the network 18 using, for example, a P2P overlay network. In this embodiment, the video sharing clients 34-1 through 34-N of the user devices 14-1 through 14-N include video sharing functions 76-1 through 76-N in addition to the auto-editing functions 72-1 through 72-N discussed above. In general, the video sharing functions 76-1 through 76-N enable sharing of video items without the video sharing system 12 of FIGS. 1 and 7.

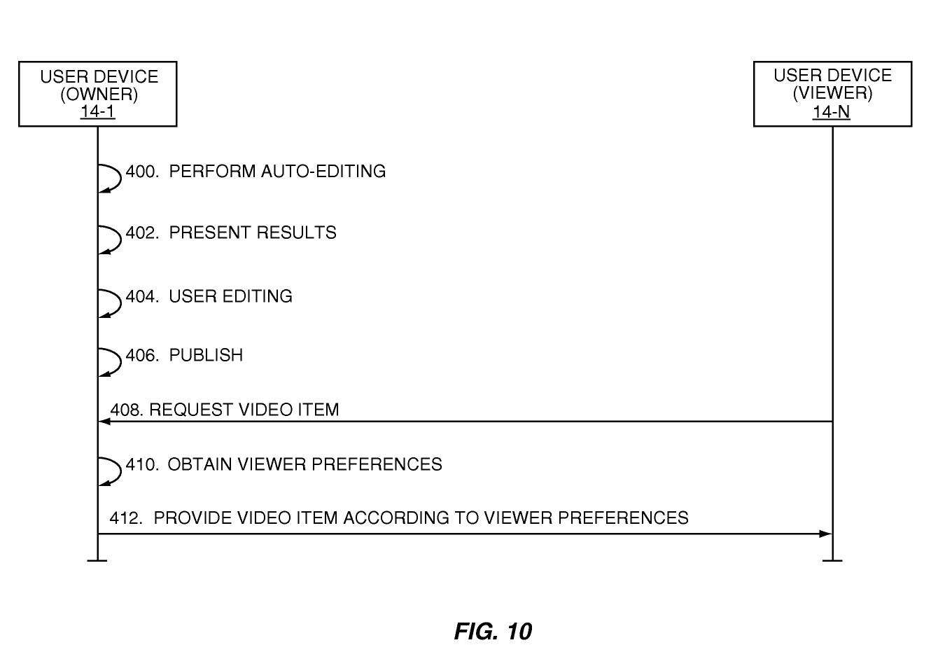

FIG. 10 illustrates the operation of the system 74 of FIG. 9 according to one embodiment of the present invention. A video item stored in locally in the storage device 36-1 of the user device 14-1 is selected to be shared and is thus referred to as a shared video item 26. The auto-editing function 72-1 of the video sharing client 34-1 of the user device 14-1 performs an auto-editing process on the shared video item 26 stored locally in the storage device 36-1 of the user device 14-1 (step 400). The auto-editing process performed by the auto-editing function 72-1 is the same as that performed by the auto-editing function 22 discussed above. As such, the details of the auto-editing process are not repeated. Results of the auto-editing process may then be presented to the user 16-1 (step 402), and the user 16-1 may then be enabled to perform advance editing (step 404). As a result of the auto-editing process and any subsequent advance editing by the user 16-1, alternate version records 30 for one or more alternate versions of the shared video item 26 are generated and stored locally in the storage device 36-1 of the user device 14-1. The user 16-1 then selects one or more of the alternate versions to publish, and the selected alternate versions are then published (step 406). The published alternate versions are thereafter available for sharing with the other users 16-2 through 16-N.

At some time thereafter, in response to user input from the user 16-N, the user device 16-N, and more specifically the video sharing client 34-N, sends a request to the user device 14-1 for the shared video item 26 shared by the user 16-1 (step 408). When requesting and subsequently viewing the shared video item 26, the user 16-N is also referred to herein as a viewer. Note that the request may be a general request for the shared video item 26, where the video sharing function 76-1 subsequently selects one of the alternate versions of the shared video item 26 that have been published to return to the user 16-N based on viewer preferences of the user 16-N. The viewer preferences may already be stored by the user device 14-1, obtained from a remote source such as a central database or the user device 14-N, or provided in the request. Alternatively, the user 16-N may be enabled to select the desired alternate version of the shared video item 26, in which case the request would be a request for the desired alternate version of the shared video item 26.

In this embodiment, in response to the request, the video sharing function 76-1 of the video sharing client 34-1 of the user device 14-1 obtains the viewer preferences of the user 16-N if the user device 14-1 has not already obtained the viewer preferences (step 410). Again, the viewer preferences of the user 16-N may have already been provided to the user device 14-1, obtained from a remote source such as a central database or the user device 14-N, or provided in the request for the shared video item 26. As mentioned above, in one embodiment, the request is a general request for the shared video item 26. As such, the video sharing function 76-1 selects one of the published alternate versions of the shared video item 26 to share with the user 16-N based on the viewer preferences of the user 16-N. In another embodiment, the request identifies the desired alternate version of the shared video item 26 to be delivered to the user 16-N at the user device 14-N.

The video sharing function 76-1 of the video sharing system 12 then provides the selected alternate version of the shared video item 26 to the user device 14-N (step 412). In this example, the video sharing function 76-1 provides the selected alternate version of the shared video item 26 according to the viewer preferences of the user 16-N. More specifically, in one embodiment, the alternate versions of the shared video item 26 are represented by the alternate version records 30, as discussed above. The alternate version record 30 for the selected alternate version may be applied to the shared video item 26 by the video sharing function 76-1 to provide the alternate version of the shared video item 26. For example, the video sharing function 76-1 may stream the shared video item 26 to the user device 14-N according to the alternate version record 30 for the selected alternate version of the shared video item 26, thereby providing the selected alternate version of the shared video item 26. Alternatively, the shared video item 26 and the alternate version record 30 for the selected alternate version of the shared video item 26 may be provided to the user device 14-N. The video sharing client 34-N of the user device 14-N may then provide playback of the shared video item 26 according to the alternate version record 30, thereby providing the alternate version of the shared video item 26.

In addition, as discussed below, the viewer preferences may be further utilized when providing the selected alternate version of the shared video item 26 to the user 16-N of the user device 14-N. More specifically, in one embodiment, data is stored by the video sharing client 34-1 identifying the objectionable content and/or undesirable content in the shared video item 26. Thus, when providing the selected alternate version of the shared video item 26 to the user device 14-N, the alternate version may be further modified according to the viewer preferences of the user 16-N.

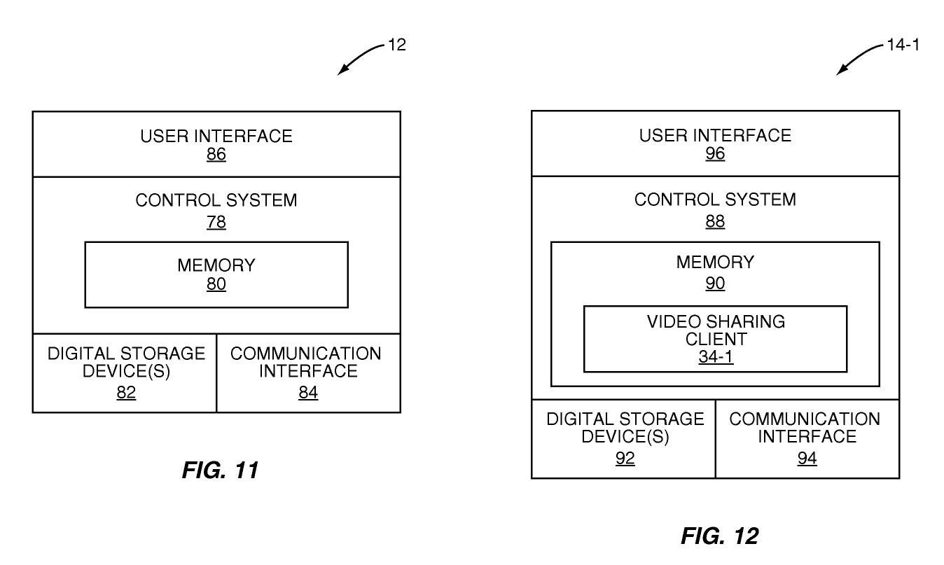

FIG. 11 is a block diagram of the video sharing system 12 of FIGS. 1 and 7 according to one embodiment of the present invention. In this embodiment, the video sharing system 12 is implemented as a computing device, such as a server, including a control system 78 having associated memory 80. The video sharing function 20 (FIGS. 1 and 7) and the auto-editing function 22 (FIG. 1) may be implemented in software and stored in the memory 80. However, the present invention is not limited thereto. In addition, the video sharing system 12 may include one or more digital storage devices 82, which may be one or more hard-disk drives or the like. In one embodiment, the shared video items 26, the alternate version records 30 of the shared video items 26 may be stored in the one or more digital storage devices 82. However, the present invention is not limited thereto. For example, all or some of the shared video items 26 and the alternate version records 30 of the shared video items 26 may be stored in the memory 80. The video sharing system 12 also includes a communication interface 84 communicatively coupling the video sharing system 12 to the network 18 (FIGS. 1 and 7). Lastly, the video sharing system 12 may include a user interface 86, which may include, for example, a display, one or more user input devices, or the like.

FIG. 12 is a block diagram of the user device 14-1 according to one embodiment of the present invention. This discussion is equally applicable to the other user devices 14-2 through 14-N. In general, the user device 14-1 includes a control system 88 having associated memory 90. In one embodiment, the video sharing client 34-1 is implemented in software and stored in the memory 90. However, the present invention is not limited thereto. The user device 14-1 may also include one or more digital storage devices 92 such as, for example, one or more hard-disk drives, one or more internal or removable memory devices, or the like. The one or more digital storage devices 92 form the storage device 36-1 (FIGS. 1, 7, and 9). The user device 14-1 also includes a communication interface 94 for communicatively coupling the user device 14-1 to the network 18 (FIGS. 1, 7, and 9). Lastly, the user device 14-1 includes a user interface 96, which includes components such as a display, one or more user input devices, one or more speakers, or the like.

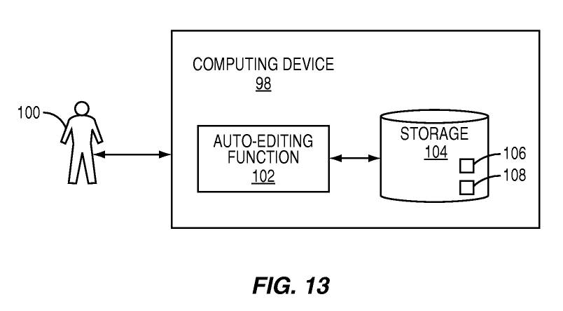

FIG. 13 illustrates a computing device 98 that performs auto-editing of video items according to another embodiment of the present invention. The computing device 98 may be, for example, a personal computer, a set-top box, a portable device such as a portable media player or a mobile smart phone, a central server, or the like. The computing device 98 may be associated with a user 100. The computing device 98 includes an auto-editing function 102 and a storage device 104. The auto-editing function 102 may be implemented in software, hardware, or a combination thereof. In general, the auto-editing function 102 operates to perform an auto-editing process on one or more video items 106 stored in the storage device 104 to provide alternate version records 108 defining one or more alternate versions for each of the video items 106. The auto-editing process is substantially the same as that described above. As such, the details are not repeated. However, in general, the auto-editing function 102 identifies objectionable content and/or undesirable content in a video item 106 and filters and/or replaces one or more instances of objectionable content and/or undesirable content based on one or more auto-editing rules to provide one or more alternate version records 108 defining one or more alternate versions of the video item 106.

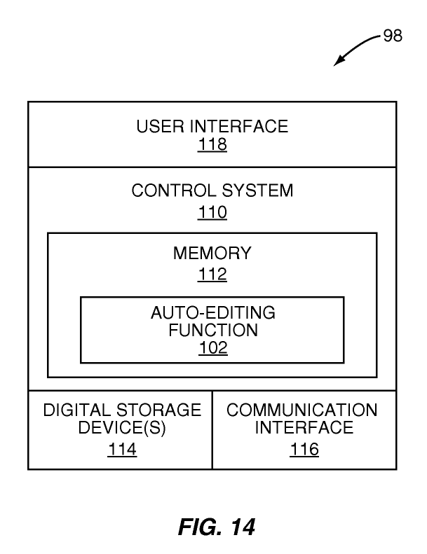

FIG. 14 is a block diagram of the computing device 98 of FIG. 13 according to one embodiment of the present invention. In general, the computing device 98 includes a control system 110 having associated memory 112. In one embodiment, the auto-editing function 102 is implemented in software and stored in the memory 112. However, the present invention is not limited thereto. The computing device 98 may also include one or more digital storage devices 114 such as, for example, one or more hard-disk drives, one or more internal or removable memory devices, or the like. The one or more digital storage devices 114 form the storage device 104 (FIG. 13). The computing device 98 may include a communication interface 116. Lastly, the computing device 98 may include a user interface 118, which may include components such as a display, one or more user input devices, one or more speakers, or the like.

Note that while the discussion herein focuses on user-generated video items, the present invention is not limited thereto. The present invention may also be used to provide auto-editing of any type of video item such as a movie, television program, user-generated video, or the like. Still further, the present invention is not limited to video items. The present invention may also be used to provide auto-editing of other types of media items. For example, the present invention may be used to provide auto-editing of audio items such as songs, audio commentaries, audio books, or the like.

Those skilled in the art will recognize improvements and modifications to the preferred embodiments of the present invention. All such improvements and modifications are considered within the scope of the concepts disclosed herein and the claims that follow.

What is claimed is:

1. A method comprising:
automatically generating proposed edits for the media item for each of one or more alternate versions of the media item;
providing, to a user associated with the media item, information indicative of the proposed edits;
receiving, from the user, a response accepting the proposed edits for an alternate version from the one or more alternate versions; and
after receiving the response, sharing the alternate version of the media item with at least one other user.

2. The method of claim 1 wherein the information indicative of the proposed edits comprises the proposed edits.

3. The method of claim 1 wherein the information indicative of the proposed edits comprises information describing the proposed edits.

4. The method of claim 1 wherein sharing the alternate version of the media item comprises:
receiving a request from a device of a requesting user for one of a group consisting of: the media item or the alternate version of the media item; and
providing the alternate version of the media item to the requesting user at the device of the requesting user.

5. The method of claim 4 wherein:
automatically generating the proposed edits for the media item for each of the one or more alternate versions of the media item comprises, for each alternate version from the one or more alternate versions, generating an alternate version record comprising the proposed edits for the alternate version; and
providing the alternate version comprises streaming the media item to the device of the requesting user according to the alternate version record for the alternate version such that the alternate version of the media item is provided to the device of the requesting user.

6. The method of claim 4 wherein:
automatically generating the proposed edits for the media item for each of the one or more alternate versions of the media item comprises, for each alternate version from the one or more alternate versions, generating an alternate version record comprising the proposed edits for the alternate version; and
providing the alternate version comprises providing the media item and the alternate version record for the alternate version to the device of the requesting user, wherein playback of the media item at the device of the requesting user is controlled according to the alternate version record such that playback of the alternate version of the media item is provided at the device of the requesting user.

7. The method of claim 4 wherein providing the alternate version comprises:
generating the alternate version from the media item according to the proposed edits; and
sending the alternate version of the media item to the device of the requesting user.

8. The method of claim 1 further comprising:
enabling the user to perform advance editing for a second alternate version of the one or more alternate versions to modify the proposed edits for the second alternate version, thereby providing modified edits for the second alternate version of the media item; and
sharing the second alternate version of the media item with at least one other user, wherein the second alternate version of the media item is provided based on the modified edits.

9. The method of claim 1 wherein the proposed edits comprise at least one of a group consisting of: removing at least one segment of the media item, replacing at least one segment of the media item with alternative content, removing at least one instance of objectionable content from the media item, removing at least one instance of undesirable content from the media item, replacing at least one instance of objectionable content with an advertisement, replacing at least one instance of undesirable content with an advertisement, replacing at least one instance of objectionable content with alternative content, replacing at least one instance of undesirable content with alternative content, muting an audio component of the media item during at least one instance of objectionable audio content, and inserting at least one advertisement location.

10. The method of claim 1 wherein automatically generating the proposed edits for the media item for each of the one or more alternate versions of the media item comprises:
identifying objectionable content in the media item; and
for each alternate version of the one or more alternate versions, generating at least one proposed edit for the media item that removes at least one instance of the objectionable content from the media item.

11. The method of claim 10 wherein the objectionable content comprises at least one of a group consisting of: profanity, violence, and nudity.

12. The method of claim 10 wherein, for each alternate version of the one or more alternate versions, automatically generating the proposed edits for the media item for the alternate version of the media item further comprises generating at least one proposed edit that replaces at least one instance of the objectionable content removed from the media item with alternative content.

13. The method of claim 12 wherein the alternative content is one of a group consisting of: an advertisement, alternative audio content, alternative visual content, and alternative audio/visual content.

14. The method of claim 10 wherein, for each alternate version of the one or more alternate versions, automatically generating the proposed edits for the media item for the alternate version of the media item further comprises generating at least one proposed edit that replaces at least one instance of the objectionable content that has not been removed from the media item with alternative content.

15. The method of claim 1 wherein automatically generating the proposed edits for the media item for each of the one or more alternate versions of the media item comprises:
identifying undesirable content in the media item; and
for each alternate version of the one or more alternate versions, generating at least one proposed edit for the media item that removes at least one instance of the undesirable content from the media item.

16. The method of claim 15 wherein the media item is a user-generated video, and the undesirable content comprises at least one of a group consisting of: a long zoom sequence, a quick zoom sequence, a long pan sequence, a quick pan sequence, a long gaze sequence, a quick glance sequence, a shaky sequence, and a sequence having essentially no activity.

17. The method of claim 15 wherein, for each alternate version of the one or more alternate versions, automatically generating the proposed edits for the media item for the alternate version of the media item further comprises generating at least one proposed edit that replaces at least one instance of the undesirable content removed from the media item with alternative content.

18. The method of claim 17 wherein the alternative content is one of a group consisting of: an advertisement, alternative audio content, alternative visual content, and alternative audio/visual content.

19. The method of claim 15 wherein, for each alternate version of the one or more alternate versions, automatically generating the proposed edits for the media item for the alternate version of the media item further comprises generating at least one proposed edit that replaces at least one instance of the undesirable content that has not been removed from the media item with alternative content.

20. The method of claim 1 wherein providing, to the user associated with the media item, the information indicative of the proposed edits comprises:
providing, to the user associated with the media item, the information indicative of the proposed edits via one of a group consisting of: one or more web pages, an email message, an instant messaging message, and a text-message.

21. The method of claim 1 wherein the method is a method of operation of a central media sharing system, and the method further comprises receiving the media item from a device of the user via a network.

22. The method of claim 21 further comprising:
automatically generating proposed edits for each of one or more alternate versions of each of a plurality of media items including the media item shared by the user; and
prioritizing the plurality of media items with respect to an order in which the plurality of media items is processed to automatically generate the proposed edits for each of the one or more alternate versions of each of the plurality of media items.

23. The method of claim 22 wherein prioritizing the plurality of media items comprises prioritizing the plurality of media items based on at least one criterion from the group consisting of: system resource cost to process each of the plurality of media items to generate the proposed edits, a data size of each of the plurality of media items, a playback length of each of the plurality of media items, subscription types of users sharing the plurality of media items, revenue derived from previous media items shared by users sharing the plurality of media items, revenue derived from previous media items shared by other users within social networks of users sharing the plurality of media items, sizes of social networks of users sharing the plurality of media items, a number of requests received for each of the plurality of media items, a popularity of each of the plurality of media items, projected income from advertisements, projected savings in bandwidth to deliver alternate versions of the plurality of media items as compared to delivering the plurality of media items, number of Motion Picture Association of America (MPAA) rating mismatches between MPAA ratings desired by viewers of each of the plurality of media items and an MPAA rating of each of the plurality of media items, and maximizing profit to operators of the central media sharing system.

24. The method of claim 1 wherein sharing the alternate version of the media item comprises:
receiving a request from a device of a requesting user for one of a group consisting of: the media item or the alternate version of the media item;
obtaining preferences of the requesting user; and
providing the alternate version of the media item to the requesting user at the device of the requesting user according to the preferences of the requesting user.

25. The method of claim 1 wherein sharing the alternate version of the media item comprises:
receiving a request from a device of a requesting user for the media item;
obtaining preferences of the requesting user;
selecting the alternate version from the one or more alternate versions based on the preferences of the requesting user; and
providing the alternate version of the media item to the requesting user at the device of the requesting user.

26. The method of claim 1 wherein the method is a method of operation of a device of the user associated with the media item, and sharing the alternate version of the media item comprises uploading the media item and the proposed edits for the media item to a central media sharing system that operates to share the alternate version of the media item with at least one other user.

27. The method of claim 1 wherein the method is a method of operation of a device of the user associated with the media file, and sharing the alternate version of the media item comprises:
generating the alternate version of the media item based on the proposed edits; and
uploading the alternate version of the media item to a central media sharing system that operates to share the alternate version of the media item with at least one other user.

28. The method of claim 1 wherein the method is a method of operation of a first peer device of the user associated with the media item, and sharing the alternate version of the media item comprises:
receiving, from a second peer device of a requesting user, a request for one of a group consisting of: the media item or the alternate version of the media item; and
providing the alternate version of the media item to the requesting user at the second peer device of the requesting user.

29. The method of claim 1 wherein the media item is a user-generated video.

30. The method of claim 1 wherein the media item is one of a group consisting of: a video item and an audio item.

31. A method comprising:
automatically generating proposed edits for a media item for each of one or more alternate versions of the media item;
providing, to a user associated with the media item, information indicative of the proposed edits;
enabling the user to perform advance editing for an alternate version of the one or more alternate versions to modify the proposed edits for the alternate version, thereby providing modified edits for the alternate version of the media item; and
sharing the alternate version of the media item with at least one other user, wherein the alternate version of the media item is provided based on the modified edits.

32. A method comprising:
automatically generating proposed edits for a media item for each of one or more alternate versions of the media item;
providing, to a user associated with the media item, information indicative of the proposed edits;
receiving a response from the user accepting the proposed edits for an alternate version from the one or more alternate versions; and
after receiving the response, applying the proposed edits for the alternate version accepted by the user to the media item to provide the alternate version of the media item.

33. A system comprising:
a communication interface communicatively coupling the system to a network; and
a control system associated with the communication interface and adapted to:
automatically generate proposed edits for a media item for each of one or more alternate versions of the media item;
provide, to a user associated with the media item, information indicative of the proposed edits;
receive, from the user, a response accepting the proposed edits for an alternate version from the one or more alternate versions; and
share the alternate version of the media item with at least one other user after the response is received.

34. A system comprising:
a communication interface communicatively coupling the system to a network; and
a control system associated with the communication interface and adapted to:
automatically generate proposed edits for a media item for each of one or more alternate versions of the media item;
provide, to a user associated with the media item, information indicative of the proposed edits;
enable the user to perform advance editing for an alternate version of the one or more alternate versions to modify the proposed edits for the alternate version, thereby providing modified edits for the alternate version of the media item; and
share the alternate version of the media item with at least one other user, wherein the alternate version of the media item is provided based on the modified edits.

35. A system comprising:
a user interface; and
a control system associated with the user interface and adapted to:
automatically generate proposed edits for a media item for each of one or more alternate versions of the media item;
provide information indicative of the proposed edits to a user associated with the media item via the user interface;
receive, from the user via the user interface, a response from the accepting the proposed edits for an alternate version from the one or more alternate versions; and
after the response is received, apply the proposed edits for the alternate version accepted by the user to the media item to provide the alternate version of the media item.
